(19) United States
(12) Patent Application Publication
(10) Pub. No.: US 2019/0148730 A1
(43) Pub. Date: May 16, 2019

(54) ELECTRODE FOR SODIUM-ION BATTERY

(71) Applicant: QATAR FOUNDATION FOR EDUCATION, SCIENCE AND COMMUNITY DEVELOPMENT, Doha (QA)

(72) Inventors: RACHID ESSEHLI, DOHA (QA); HAMDI BEN YAHIA, DOHA (QA); ILIAS BELHAROUAK, DOHA (QA)

(21) Appl. No.: 16/192,259

(22) Filed: Nov. 15, 2018

Related U.S. Application Data
(60) Provisional application No. 62/586,803, filed on Nov. 15, 2017.

(51) Int. Cl. H01M 4/583; H01M 4/58; H01M 10/0561

(52) U.S. Cl. CPC H01M 4/5835; H01M 2004/028; H01M 10/0561; H01M 4/5825

(57) ABSTRACT

The electrode for sodium-ion batteries is a fluorine-doped sodium metal hydroxide phosphate having the general formula Na₃V₂(PO₄)₂F₃₋ₓ(OH)ₓ, wherein 0<x≤3. Materials comprising such compounds can be used as a positive electrode material for rechargeable sodium-ion batteries. The compounds of the present disclosure may be produced by a hydrothermal synthesis route.

### CROSS-REFERENCE TO RELATED APPLICATIONS

This application claims the benefit of U.S. Provisional Patent Application Ser. No. 62/586,803, filed Nov. 15, 2017.

### BACKGROUND

### 1. Field

The disclosure of the present patent application relates to sodium-ion batteries, and particularly to an electrode for a sodium-ion battery that is a fluorine-doped sodium metal hydroxide phosphate compound that can be used in a positive electrode for a rechargeable sodium-ion battery.

### 2. Description of the Related Art

Lithium-ion rechargeable batteries have been commercially available for several years. However, lithium metal is a scarce resource, and with demand for lithium-ion batteries constantly increasing, the price of lithium has been steadily increasing. Consequently, there is renewed interest in developing a sodium-ion battery, since the two elements have similar properties, but sodium is cheaper and more readily available. In one important respect, however, sodium is different from lithium, viz., sodium is a larger atom than lithium. The effect of this difference in size is that sodium ions are not transported through electrolyte as quickly as lithium ions, causing a slower response to a sudden demand for current. Hence, some of the technology developed for lithium electrodes and electrodes does not carry over directly to electrodes and electrolytes for sodium-ion batteries. There is a need for developing electrodes and electrolytes having properties consistent with their use in sodium-ion batteries.

Thus, an electrode for sodium-ion batteries solving the aforementioned problems is desired.

### SUMMARY

The electrode for sodium-ion batteries is a fluorine-doped sodium metal hydroxide phosphate having the general formula Na₃V₂(PO₄)₂F₃₋ₓ(OH)ₓ, wherein 0<x≤3. Materials comprising such compounds can be used as a positive electrode material for rechargeable sodium-ion batteries. The compounds of the present disclosure may be produced by a hydrothermal synthesis route.

These and other features of the present disclosure will become readily apparent upon further review of the following specification and drawings.

### BRIEF DESCRIPTION OF THE DRAWINGS

FIG. 1 is a powder X-ray diffractogram of Na₃V₂(PO₄)₂F₂OH, synthesized as described herein.

FIG. 2A is a scanning electron microscopy (SEM) micrograph of Na₃V₂(PO₄)₂F(OH)₂.

FIG. 2B is a SEM micrograph of Na₃V₂(PO₄)₂(OH)F₂.

FIG. 3 is the FT-IR spectra of Na₃V₂(PO₄)₂F₃,(OH)ₓ, including the spectrum of Na₃V₂(PO₄)₂(OH)F₂ and the spectrum of Na₃V₂(PO₄)₂F(OH)₂.

FIG. 4 is the galvanostatic charge/discharge curves of Na₃V₂(PO₄)₂(OH)F₂.

FIG. 5 is a plot of the galvanostatic charge/discharge curves of Na₃V₂(PO₄)₂F(OH)₂.

FIG. 6 is a plot of the galvanostatic charge/discharge curves of the Na₃V₂(PO₄)₂F(OH)₂//LTO full cell in EC-PC (ethylene carbonate-propylene carbonate) electrolyte.

Similar reference characters denote corresponding features consistently throughout the attached drawings

### DETAILED DESCRIPTION OF THE PREFERRED EMBODIMENTS

The electrode for sodium-ion batteries is a fluorine-doped sodium metal hydroxide phosphate having the general formula Na₃V₂(PO₄)₂F₃,(OH)ₓ, wherein 0<x≤3.

The materials and the compounds of the present disclosure may be made by hydrothermal synthesis. Compounds of formula Na₃V₂(PO₄)₂F₃₋ₓOₓ have been made before. Hydrothermal synthesis makes it possible to replace fluorine or oxygen by a hydroxyl group.

The compounds of formula Na₃V₂(PO₄)₂F₃₋ₓ(OH)ₓ may provide electrodes with high potential for electrochemical energy storage batteries in grid applications for connection to the electrical grid in renewable energy sources, such as wind power, solar or photovoltaic power systems, etc.

The compounds have similar crystal structure to compounds of the general formula Na₃M₂(PO₄)₂F₃₋ₓOₓ, wherein 0<x≤3 and M³⁺=a transition metal.

A device, typically a battery, may be made with a positive electrode formed from material of formula Na₃V₂(PO₄)₂F₃₋ₓ(OH)ₓ, wherein 0<x≤3, an anode or negative electrode capable of exchanging sodium ions with the positive electrode, and a suitable electrolyte. The battery may be a wet-cell or a dry cell battery.

The electrode will be better understood with reference to the following examples.

### Example 1

### Synthesis of Electrode Material

The Na₃V₂(PO₄)₂F₃₋ₓ(OH)ₓ compounds where 0<x≤3 were successfully prepared using a hydrothermal method from stoichiometric mixtures of NaF (Aldrich, ≥99%), NH₄VO₃ (Aldrich, ≥99.99%), NaOH, (Aldrich, ≥99.99%), NH₄H₂PO₄ (Aldrich, 99.99%) and citric acid (C₆H₈O₇) (CA). CA was employed as carbon source and reducing agent (RA). First, NH₄VO₃ and CA were dissolved in 40 ml of water to form a clear blue solution (Solution A). The NaF, NaOH and NH₄H₂PO₄ were dissolved together in 40 ml of H₂O (Solution B). Solution B was then added dropwise to Solution A under continuous stirring. The solution is finally poured into a 100 mL autoclave, which was then heated at 200° C. for 20 h. The powder obtained after filtering the solution was dried at 100° C. for 12 h under vacuum. The progress of the reaction was followed by powder X-ray diffraction (PXRD).

The precursors for the synthesis can also be replaced, as follows. NH₄VO₃ may be replaced by VOSO₄, VCl₃.xH₂O, VOC₂O₄, V₂O₅, V₂O₃, and VO₂. (NH₄)₂HPO₄, H₃PO₄, Na₂HPO₄, or NaH₂PO₄ may replace NH₄H₂PO₄. NH₄F or HF may replace NaF. Finally, the reducing agent, (RA) is not limited to citric acid (C₆H₈O₇) (CA), but may be oxalic acid H₂C₂O₄ (OA), formic acid (HCOOH) or maleic acid C₄H₄O₄.

### Example 2

### Characterization by Powder X-Ray Diffraction (PXRD)

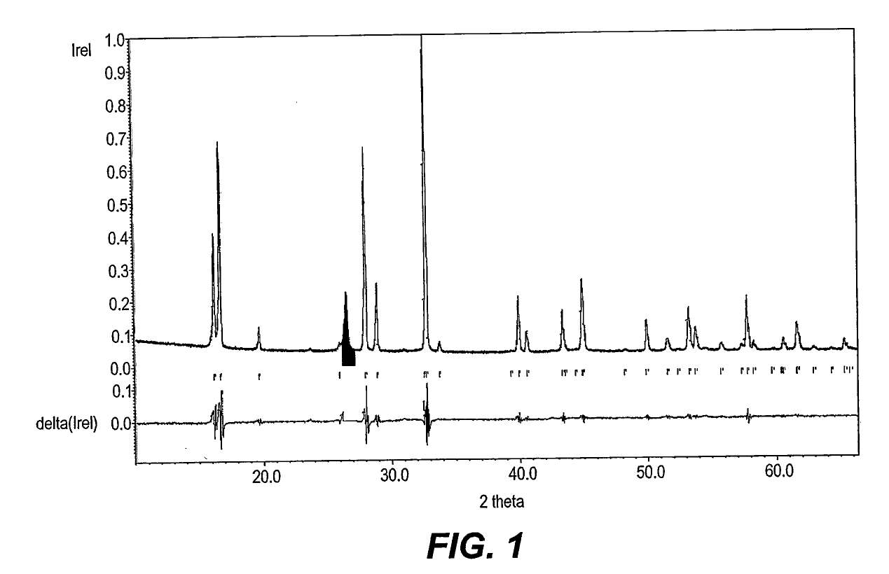

To ensure the purity of the Na₃V₂(PO₄)₂F₃₋ₓ(OH)ₓ compounds, where 0<x≤3, PXRD measurements were performed. The data were collected at room temperature over the 2θ angle range of 10°≤2θ≤70° with a step size of 0.01° using a Bruker d8 Avanced diffractometer operating with CuKα radiations. Full pattern matching refinement was performed with the Jana2006 program package. The resulting diffractogram is shown in FIG. 1. The background was estimated by a Legendre function, and the peak shapes were described by a pseudo-Voigt function. Evaluation of these data revealed the refined cell parameters listed in Table 1.

TABLE 1
Crystallographic data for Na₃V₂(PO₄)₂F₃₋ₓ(OH)ₓ compounds

| | Na₃V₂(PO₄)₂F₂OH | Na₃V₂(PO₄)₂F(OH)₂ |
|---|---|---|
| a(Å) | 6.38684(12) | 6.38626(19) |
| b(Å) | 6.38684(12) | 6.38626(19) |
| c(Å) | 10.6303(3) | 10.6323(5) |
| V(Å³) | 433.629(18) | 433.63(3) |
| Space Group | I4/mmm | I4/mmm |

Based on the full pattern matching performed on all the Na₃V₂(PO₄)₂F₃₋ₓ(OH)ₓ samples, the powder patterns could be indexed using the space group I4/mmm. This indicates that the crystal structures of our compounds are isostructural to Na₃Cr₂(PO₄)₂F₃. The [V₂(PO₄)₂F₃₋ₓ(OH)ₓ]³⁻ frameworks are very similar to [M₂(PO₄)₂F₃]³⁻ frameworks of the Na₃M₂(PO₄)₂F₃ compounds, even though they crystallize with different space groups (I4/mmm, P4₂/mnm, P4₂/mbc, Cmcm, Cmc2₁, or Pbam). During cycling, phase transitions from I4/mmm to P4₂/mnm, P4₂/mbc, Cmcm, Cmc2₁, or Pbam are expected.

### Example 3

### SEM Analysis

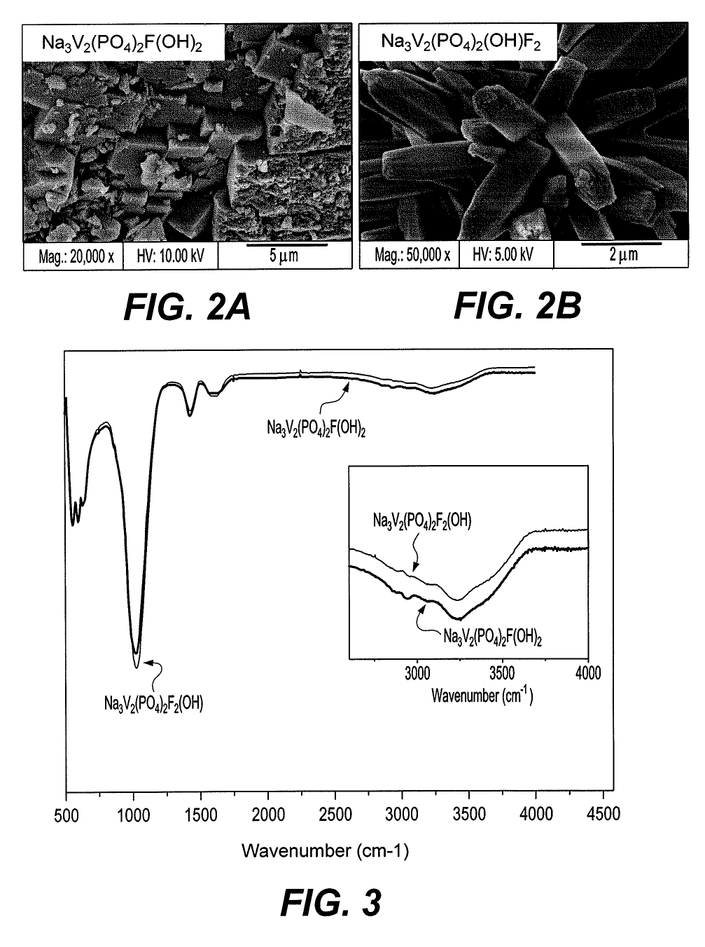

Semiquantitative energy dispersive X-ray spectrometry (EDX) analyses of the powder were carried out with a SEM-JSM-7500F scanning electron microscope (SEM). A SEM micrograph of Na₃V₂(PO₄)₂F(OH)₂ is shown in FIG. 2A. A SEM micrograph of Na₃V₂(PO₄)₂OH is shown in FIG. 2B.

### Example 4

### FT-IR Spectroscopic Analysis

The FT-IR spectra of Na₃V₂(PO₄)₂F₃₋ₓ(OH)ₓ, (x=1 and 2) is shown in FIG. 3. The band at 3350 cm⁻¹ is known to be due to the vibrational stretching of OH structural groups.

### Example 5

### Voltammograms

Positive electrodes were made from mixtures of Na₃V₂(PO₄)₂F₃₋ₓ(OH)ₓ powders, acetylene black (AB) and polyvinylidene fluoride (PVDF) in a weight ratio of 80:10:10. The resulting electrode film was pressed with a twin roller, cut into a round plate (Φ=14 mm) and dried at 120° C. for 12 h under vacuum. The electrolyte was 1 M NaPF₆ dissolved in ethylene carbonate (EC) and propylene carbonate (PC) [EC/PC with 1/1 in volume ratio]. Coin-type cells (CR2032) embedding Na₃V₂(PO₄)₂F₃₋ₓ(OH)ₓ/NaPF₆+EC+PC/Na were assembled in an argon-filled glove box with a Whatman GF/C glass fiber separator. Room temperature galvanometric cycling tests (Constant current mode) were performed using an Arbin battery tester system in a potential range of 2.0-4.5 V at different rates, whereas the cyclic voltammetry tests were performed using a Solartron battery tester system.

The electrolyte salt can be chosen from, but not limited to, NaPF₆, NaClO₄, and NaBF₄. The electrolyte solvent can be chosen from, but not limited to, Ethylene carbonate (EC), Propylene carbonate (PC), Dimethyl carbonate (DMC), and Diethyl carbonate (DEC).

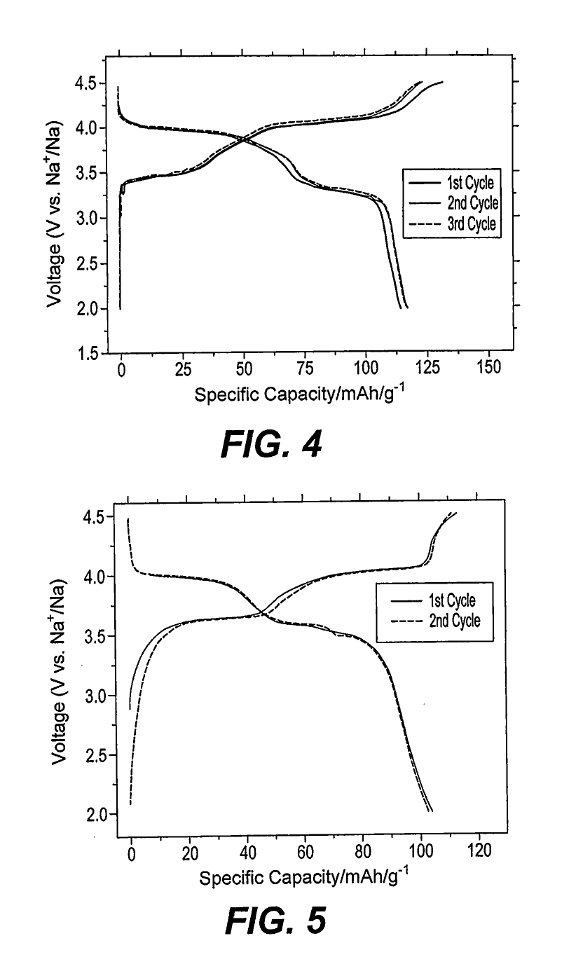

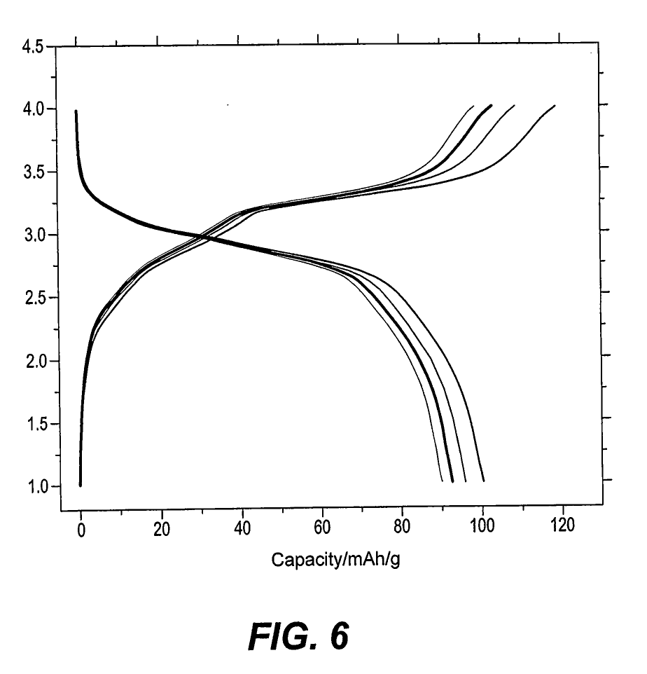

The Galvanostatic charge and discharge curves show that at 1C rate, Na₃V₂(PO₄)₂F₃₋ₓ(OH)ₓ delivers a discharge capacity of 115 and 107 mAh/g for Na₃V₂(PO₄)₂F₂(OH) and Na₃V₂(PO₄)₂F(OH)₂, respectively (see FIGS. 4 and 5), with an average operational voltage around 3.8V. This leads to an energy density above 400 Wh/kg, which is excellent for practical applications. It should be mentioned that this energy density is calculated based on the cathode only. The performance in full cell using Li₅Ti₄O₁₂ anode is also good (see FIG. 6). A better result is expected with hard carbon.

It is to be understood that the electrode for a sodium-ion battery is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. An electrode for a sodium-ion battery, comprising a compound of the formula Na₃V₂(PO₄)₂F₃₋ₓ(OH)ₓ, wherein 0<x≤3.

2. The electrode according to claim 1, wherein the compound has the formula Na₃V₂(PO₄)₂F(OH)₂.

3. The electrode according to claim 1, wherein the compound has the formula Na₃V₂(PO₄)₂F₂(OH).

4. The electrode according to claim 1, further comprising a conductive carbon powder and a polymer binder mixed with the compound of the formula Na₃V₂(PO₄)₂F₃₋ₓ(OH)ₓ.

5. The electrode according to claim 1, further comprising acetylene black and polyvinylidene fluoride mixed with the compound of the formula Na₃V₂(PO₄)₂F₃₋ₓ(OH)ₓ, the mixture being pressed to form a dense electrode body.

6. A sodium-ion battery made with the electrode according to claim 1.

7. A sodium-ion battery, comprising:
the electrode according to claim 1 configured as a positive electrode;
a negative electrode selected from the group consisting of hard carbon, Li₄Ti₅O₁₂ (LTO), and NaTi2(PO4)3 (NTP); and
a sodium-based electrolyte, the positive electrode and the negative electrode being disposed in contact with the electrolyte.

8. The sodium-ion battery according to claim 7, wherein the electrolyte is a salt selected from the group consisting of NaPF₆, NaClO₄, and NaBF₄.

9. The sodium-ion battery according to claim 8, wherein the electrolyte salt is moistened with a solvent selected from the group consisting of ethylene carbonate (EC), propylene carbonate (PC), dimethyl carbonate (DMC), and diethyl carbonate (DEC).

10. A method of making a compound of formula Na₃V₂(PO₄)₂F₃₋ₓ(OH)ₓ, wherein 0<x≤3, comprising the step of substituting a hydroxyl group (—OH) for a fluorine atom or an oxygen atom in a compound of formula Na₃V₂(PO₄)₂F₃₋ₓOₓ by hydrothermal synthesis.

11. A method of making a compound of formula Na₃V₂(PO₄)₂F₃₋ₓ(OH)ₓ, wherein 0<x≤3, comprising the steps of:
dissolving citric acid and NH₄VO₃ in water to form a first solution;
dissolving stoichiometric amounts of NaF, NaOH and NH₄H₂PO₄ in water to form a second solution;
adding the second solution to the first solution dropwise under continuous stirring to form a reaction mixture;
heating the reaction mixture at 200° C. for 20 hours to obtain a precipitate;
filtering the precipitate from the reaction mixture; and
drying the precipitate under vacuum to obtain the compound as a powder.
